(19) United States
(12) Patent Application Publication
(10) Pub. No.: US 2004/0208611 A1
(43) Pub. Date: Oct. 21, 2004

(54) Method of preventing reflections in an optical wireless link

(76) Inventors: Eric G. Oettinger, Rochester, MN (US); Mark D. Heminger, Rochester, MN (US); Mark D. Hagen, Rochester, MN (US); Karl K. Northrup, Rochester, MN (US); Robert E. Jansen, Byron, MN (US); James E. Noxon, Rochester, MN (US); Grant S. Christiansen, Rochester, MN (US)

Correspondence Address: TEXAS INSTRUMENTS INCORPORATED, P O BOX 655474, M/S 3999, DALLAS, TX, 75265

(21) Appl. No.: 10/131,445

(22) Filed: Apr. 24, 2002

(51) Int. Cl. H04B 10/00

(52) U.S. Cl. 398/149

(57) ABSTRACT

A technique that eliminates or minimizes the effects of reflective surfaces to reduce or eliminate interference in the data stream and allow an optical wireless communication link to be used reliably. The most important reflective surface is the reflective surface in front of the data detector itself, as that is the one that will be reflected after the transmitting and receiving stations are properly aligned. The greatest reduction in reflected data associated with a remote detector is then achieved by angling the surface in front of the data detector itself, such that reflections from that surface will not fall within the field of view of the remote detector once the stations are properly aligned.

### BACKGROUND OF THE INVENTION

1. Field of the Invention

This invention relates generally to optical wireless communication links, and more particularly, to a method of preventing reflections which interfere with data communications in an optical wireless link.

2. Description of the Prior Art

An optical wireless link system consists of two stations: each of which contains an optical transmitter and an optical receiver. After the two stations are properly aligned, such that the beam from the transmitter of each station is directed at the receiver of the opposite station, reflected data can cause interference in the data stream (i.e. servo position and customer data) of the optical wireless communication link, if the stations are positioned such that the transmitted beam from one station is reflected off the second station back into the receiver of the first station. The effects of reflective surfaces must therefore be eliminated or minimized.

In view of the foregoing, it would be desirable and advantageous in the optical wireless communication art to provide a technique that eliminates or minimizes the effects of reflective surfaces to reduce or eliminate interference in the data stream and allow an optical wireless communication link to be used reliably without undue processing requirements.

### SUMMARY OF THE INVENTION

The present invention is directed to a technique that eliminates or minimizes the effects of reflective surfaces to reduce or eliminate interference in the data stream and allow an optical wireless communication link to be used reliably. The most important reflective surface(s) is/are the reflective surface(s) in front of the data detector itself, as that is the one that will be reflected after the transmitting and receiving stations are properly aligned. The greatest reduction in reflected data associated with a remote detector is then achieved by angling the surface(s) in front of the data detector itself, such that reflections from that surface will not fall within the field of view of the remote detector once the stations are properly aligned.

In one aspect of the invention, a method is provided for preventing interference in the data stream of an optical wireless communication link without causing additional overhead in data processing time associated with detection and error handling.

In another aspect of the invention, a method is provided for preventing interference in the data stream of an optical wireless communication link without causing any interference or throughput issues in the data stream.

### BRIEF DESCRIPTION OF THE DRAWINGS

Other aspects, features and advantages of the present invention will be readily appreciated, as the invention becomes better understood by reference to the following detailed description when considered in connection with the accompanying drawing figure wherein:

FIG. 1(a) is a pictorial illustrating beam divergence associated with an optical wireless transmitter and a field of view associated with an optical wireless receiver;

FIG. 1(b) is a perspective view showing a signal transmitted from an optical wireless link being reflected back into a data detector associated with the optical wireless link; and

FIG. 1(c) is a perspective view showing a signal transmitted from an optical wireless link reflected out of the field of view of a data detector associated with the optical wireless link according to one embodiment of the present invention.

While the above-identified drawing figure sets forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

As stated herein before, an optical wireless link system consists of two stations: each of which contains a transmitter and a receiver. After the two stations are properly aligned, the reflected beam from one station can cause interference in the data stream (i.e. servo position and customer data) from the remote station of the optical wireless communication link. The effects of reflective surfaces must therefore be eliminated or minimized.

U.S. patent application Ser. No. 10/056,688 (’688 application), entitled Reflection Detection In An Optical Wireless Link, filed on Jan. 24, 2002, by Eric G. Oettinger and Mark D. Heminger, addresses reflections via recognition and appropriate error handling. That approach however, requires processing overhead, as well as possible transmission rate degradation due to interference of the data signal from the reflection. The ’688 application is assigned to the assignee of the present invention, and is hereby incorporated by reference in its entirety herein.

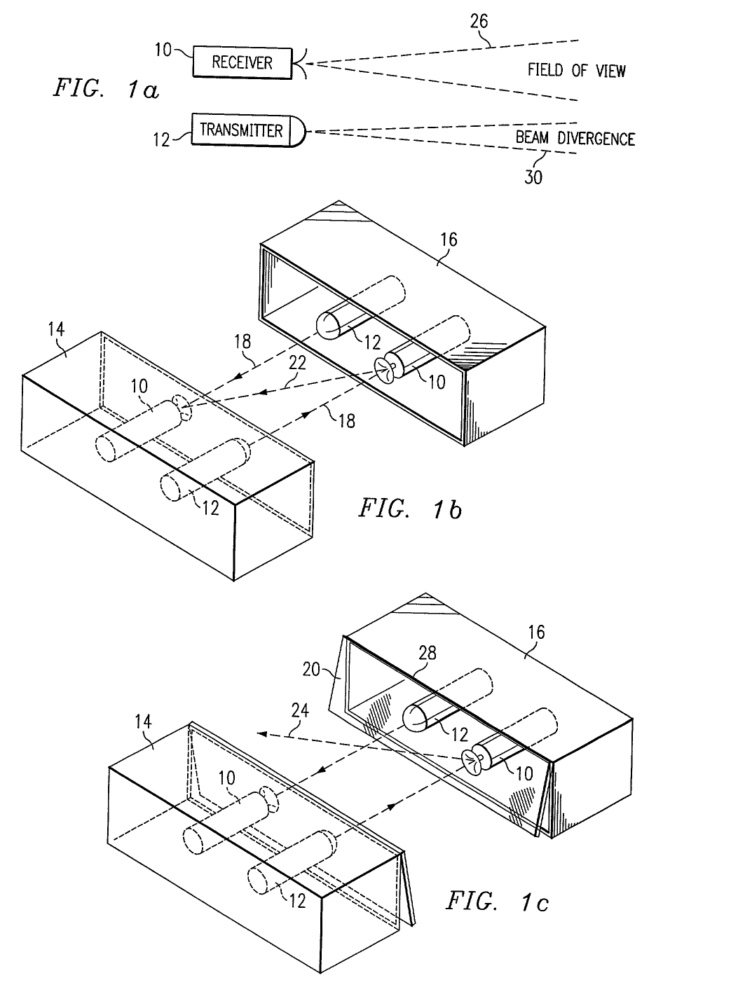

FIG. 1(a) illustrates an optical wireless receiver 10 and an optical wireless transmitter 12. Receiver 10 and transmitter 12 are contained within a single transceiver unit such as illustrated in FIGS. 1(b) and 1(c) discussed herein below.

FIG. 1(b) illustrates a pair of optical wireless links (OWLs), 14, 16, each including a receiving data detector 10, and a transmitter 12 associated with a desired optical wireless communication path 18 (the beam divergence associated with the data path is omitted for drawing clarity). Each OWL 14, 16 makes use of a dust/light cover 20, depicted more clearly in FIG. 1(c) discussed herein below, that is placed in front of the receiving station's data detector 10. Since the communication path 18 is an optical path, reflections 22 from the dust/light cover 20 were discovered by the present inventors to cause interference in the communication path 18 when the stations were positioned such that the reflected beam 22 from the first station 14, was aligned with the receiver 10 of that same station 14.

FIG. 1(c) illustrates the OWLs 14, 16 shown in FIG. 1(b), but having the dust/light cover 20 for OWLs 14, 16 tilted to prevent reflections to eliminate or minimize interference in the data stream communication path 18 that may contain, for example, both servo position and customer data. With continued reference also to both FIGS. 1(a) and 1(b), a method of preventing reflections in an optical wireless link according to one embodiment is now described in further detail below.

During the normal data transferring operation of an optical wireless link (OWL), 14, 16, the transmitted beam from a first OWL 14 is received at a second OWL's 16 receiver 10 after passing through some filter such as dust/light cover 20 (used to keep dust out, filter ambient light, and the like). If this filter has any reflective properties, and is aligned such that the incident beam along communication path 18 is reflected back at the detector of the first OWL 14, the first OWL's 14 detector 10 will see not only the transmitted beam 18 from the second OWL 16, but also it's own transmitted data. The phenomenon will cause interference with the data stream and result in deterioration of the communication path 18 between OWL 14 and OWL 16.

Depending upon the particular data protocol in use, the data transmitted in the communication path 18, then reflected back to the transmitting station may or may not be used; and either hardware or software in use may prevent the respective servo system from reacting to the reflected beam 22 shown in FIG. 1(b). Regardless, the simple existence of this stray beam 22 will tend to invoke additional overhead processing necessary to recognize the beam 22 as a reflection. Further, the reflected beam 22 is very likely to interfere with the desired data from the remote station, preventing the intended data from actually being transmitted.

The present inventors found that mounting the dust/light cover (filter) 20 at an angle greater than the field of view 26 of the detector depicted in FIG. 1(a), then prevented reflections from interfering with the data stream during normal operation, regardless of the initial alignment of the OWLs 14, 16. This technique can then be seen to provide a method that prevents interference in the data stream of an optical wireless communication path 18 without causing additional overhead in data processing time associated with detection and error handling. Further, those skilled in the art will readily appreciate this technique provides a method for preventing interference in the data stream of an optical wireless communication link without causing any interference or throughput issues in the data stream. The filter 20 can be configured with an adjustable hinge 28, for example, that functions via a rotatable friction fit. The present invention is not so limited however, and those skilled in the art will readily recognize that many other means for adjusting the reflective angle associated with the filter 20 can also be employed, so long as the required function of reflecting signals outside the field of view associated with the receiving station 10 is achieved. Most preferably, the filter 20 is placed in a fixed orientation, using the actual OWL 14, 16 enclosure to determine its angle.

In view of the above, it can be seen the present invention presents a significant advancement in the art of optical wireless communication techniques. Further, this invention has been described in considerable detail in order to provide those skilled in the optical wireless communication art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A method of preventing reflections in an optical wireless link (OWL), the method comprising the steps of:
providing an OWL having means for filtering ambient light; and
positioning the means for filtering ambient light such that a reflective surface associated with the means for filtering ambient light is incapable of reflecting signals transmitted to the OWL by a like, but remote OWL, into a field of view associated with the remote OWL.

2. An optical wireless link (OWL) comprising:
means for transmitting an optical data signal;
means for receiving an optical data signal; and
means for filtering light, wherein the means for filtering light is configured to prevent signals transmitted to the OWL by a remote OWL, from being reflected via the means for filtering light into a field of view associated with the remote OWL.

3. The OWL according to claim 2 wherein the means for filtering light is further configured as a dust filter.

4. The OWL according to claim 2 wherein the means for filtering light is further configured to filter ambient light.

5. The OWL according to claim 2 wherein the means for filtering light comprises:
a light filter having at least one reflective surface; and
means for adjusting a relative angle associated with the at least one reflective surface.

6. An optical wireless link (OWL) comprising:
an optical data signal transmitter;
an optical data signal receiver; and
a light filter having at least one reflecting surface, wherein a relative angle of reflection associated with the at least one reflecting surface is configured to prevent signals transmitted to the OWL by an optical data signal transmitter associated with a like, but remote OWL, from being reflected via the at least one reflecting surface, into a field of view associated with the remote OWL.

7. The OWL according to claim 6 wherein the light filter is further configured as a dust cover.

8. The OWL according to claim 6 wherein the light filter is further configured to filter ambient light.
